(19) United States
(12) Patent Application Publication
(10) Pub. No.: US 2026/0170670 A1
(43) Pub. Date: Jun. 18, 2026

(54) LASER RADAR POINT CLOUD REGISTRATION METHOD FOR URBAN DYNAMIC ENVIRONMENT

(71) Applicant: SOUTHEAST UNIVERSITY, Jiangsu (CN)

(72) Inventors: Xu LI, Jiangsu (CN); Kun WEI, Jiangsu (CN); Zheming TIAN, Jiangsu (CN)

(73) Assignee: SOUTHEAST UNIVERSITY, Jiangsu (CN)

(21) Appl. No.: 19/530,371

(22) Filed: Feb. 5, 2026

Related U.S. Application Data
(63) Continuation of application No. PCT/CN2023/114343, filed on Aug. 23, 2023.

(30) Foreign Application Priority Data
Aug. 8, 2023 (CN) 202310992111.4

(51) Int. Cl. G06T 7/33; G06T 7/10

(52) U.S. Cl. CPC G06T 7/337; G06T 7/10; G06T 2207/10028; G06T 2207/20081; G06T 2207/20084; G06T 2207/30181

(57) ABSTRACT

The present invention provides a laser radar point cloud registration method for an urban dynamic environment. The method comprises: first, establishing a data set of a point cloud registration network; then, constructing a point cloud registration network based on multi-task learning; next, training the designed point cloud registration network; and finally, using the trained network to estimate a transformation matrix of two frames of point clouds. According to the method, a three-dimensional point cloud is converted into a two-dimensional distance image, improving the efficiency of point cloud processing. According to the method, two tasks of point cloud segmentation and registration are executed, and due to a shared feature extraction module, point cloud registration can be carried out on the basis of reliable features of static reference targets, reducing errors caused by dynamic targets.

### CROSS-REFERENCE TO RELATED APPLICATION

This application is a continuation of international application of PCT application serial no. PCT/CN2023/114343 filed on Aug. 23, 2023, which claims the priority benefit of China application no. 202310992111.4 filed on Aug. 8, 2023. The entirety of each of the above-mentioned patent applications is hereby incorporated by reference herein and made a part of this specification.

### TECHNICAL FIELD

The present disclosure relates to a point cloud registration method, and in particular to a laser radar point cloud registration method for an urban dynamic environment, belonging to the technical field of vehicle positioning.

### BACKGROUND

Positioning is a key module of an intelligent vehicle, and provides accurate position information for perception, decision-making, control, and other modules. In an open urban environment, a combined navigation system integrating a global navigation satellite system (GNSS) and an inertial navigation system (INS) can meet requirements for high-precision positioning of intelligent vehicles. However, in urban canyons and tree-lined roads, and under overpasses, satellite signals are shielded to varying degrees, such that it is difficult for the combined navigation system to maintain high positioning accuracy. In urban satellite-denied environments, vehicle positioning technologies in the prior art are mainly based on wireless sensors, cameras, and laser radars. Compared with wireless sensors and cameras, laser radars have the advantages of high measurement accuracy and insensitivity to lighting conditions, becoming a preferred choice for intelligent vehicle companies such as Google and Baidu. With the maturity of production technology, laser radars have been widely applied in intelligent vehicles as costs are greatly reduced.

Point cloud registration is a key step based on laser radar positioning technology, and is used to estimate a transformation matrix between two frames of point clouds. Initially, researchers conducted research on point cloud registration from the perspective of optimization. An optimization-based method is used to iteratively perform correspondence search and transformation estimation to obtain an optimal transformation matrix. With the development of deep learning, researchers have proposed a learning-based method. First, a correspondence is obtained based on extracted features, and then a transformation matrix is estimated by using a neural network. Unlike the optimization-based method, the learning-based method does not require iterative operations. Most optimization-based or learning-based point cloud registration methods assume that positions of all targets in an environment remain unchanged, i.e., this a static environment assumption. However, many dynamic targets exist in urban road environments, such as pedestrians and moving vehicles. Therefore, dynamic targets reduce the accuracy of point cloud registration.

### SUMMARY

To solve the problem that dynamic targets reduce the accuracy of point cloud registration, the present disclosure provides a laser radar point cloud registration method for an urban dynamic environment. According to the method, a three-dimensional (3D) point cloud is converted into a two-dimensional (2D) distance image, improving the efficiency of point cloud processing. According to the method, two tasks of point cloud segmentation and registration are executed, and due to a shared feature extraction module, point cloud registration can be carried out on the basis of reliable features of static reference targets, reducing errors caused by dynamic targets.

To achieve the above objective, the present disclosure provides the following technical solution: a laser radar point cloud registration method for an urban dynamic environment, including the following steps:
S1: establishing a data set of a point cloud registration network;
S2: constructing a point cloud registration network based on multi-task learning: the point cloud registration network based on multi-task learning includes a static reference target feature extraction module and a point cloud segmentation and registration module, where,

### 1) The Static Reference Target Feature Extraction Module

a 3D point cloud is converted into a 2D distance image by means of spherical projection, where point cloud coordinates (x, y, z) are converted into image coordinates (u, v):

$$( \begin{matrix}u \\ v\end{matrix} ) = ( \begin{matrix}\frac{1}{2} [ 1 - arctan ( y , x ) {π}^{- 1} ] w \\ [ 1 - ( arcsin ( z , {r}^{- 1} ) + {f}_{up} ) {f}^{- 1} ] h\end{matrix} )$$

where w and h represent a width and height of a distance image, r represents a distance of each point, r=\sqrt{x²+y²+z²}, f represents a vertical field of view of a laser radar, and fᵤₚ represents an upward angle of f; the coordinates (x, y, z), distance r, and reflectivity i of each frame of point cloud are stored in a distance image with a size of [w×h×5];
the static reference target feature extraction module inputs distance images at moments k−1 and k, and outputs static reference target features;
the two distance images are decomposed into n image patches, n=(2×w×h)/(\dot{w}×\dot{h}), a size of each image patch is [\dot{w}×\dot{h}×5], each image patch is expanded into a J-dimensional vector, J=5×\dot{w}×\dot{h}, and the two distance images are represented as a sequence \dot{Q}=[q₁, q₂, . . . , qₙ], q∈ [symbol] ;
static reference target features are extracted by using a Transformer encoder, a vector dimension processed by the Transformer encoder is K, the sequence \dot{Q} is converted into a sequence \ddot{Q}=[q₁E, q₂E, . . . , qₙE] through a learnable linear projection E∈ [symbol] and a learnable registration vector q₀∈ [symbol] is added to the sequence \ddot{Q}, to obtain a sequence \dot{\ddot{Q}}=[q₁E, q₂E, . . . , qₙE];
a learnable position vector P∈ [symbol] is added to the sequence \ddot{\dot{Q}}, to obtain a Transformer encoder input Q₀=[q₀, q₁E, q₂E, . . . qₙE]+P;
the Transformer encoder has L modules, each of the modules includes a multi-head self-attention (MHSA) layer and a multi-layer perceptron (MLP) layer, layer normalization (LN) is performed before data enters each layer, residual connections are used to fuse an output and input of each layer, and a feature calculation process of a module 1 is as follows:

$${Q}_{1}^{′} = MSA ( LN ( {Q}_{1 - 1} ) ) + {Q}_{1 - 1} , 1 = 1 , 2 , ... , L$$

$${Q}_{1} = MLP ( LN ( {Q}_{1}^{′} ) ) + {Q}_{1}^{′} , 1 = 1 , 2 , ... , L$$

a static reference target feature Q_{L} is obtained based on Q₀ through the Transformer encoder;

### 2) The Point Cloud Segmentation and Registration Module

the static reference target feature Q_{L} is a sequence of n+1 K-dimensional vectors, a vector with an index 0 is used to estimate a transformation matrix Z_{k-1, k}=[R_{k-1, k}t_{k-1, k}] at the moments k−1 to k, vectors with indices 1 to 0.5n are used to obtain a static reference target segmentation result at the moment k−1, vectors with indices 0.5n+1 to n are used to obtain a static reference target segmentation result at the moment k, and the same operation, i.e., parameter sharing, is performed for segmentation at both the two moments;
the transformation matrix Z_{k-1, k} is obtained through a designed neural network, the neural network includes one input layer, two hidden layers, and one output layer, and a Tanh activation function is added to neurons in the hidden layers;
a process of obtaining a static reference object segmentation result includes three steps: first converting 0.5n K-dimensional vectors into 0.5n J-dimensional vectors through linear projection, then transforming and sorting the 0.5n J-dimensional vectors to obtain a feature map with a size of [w×h×5], and finally processing the feature map using a 1×1 convolution kernel and a Softmax function to obtain the static reference object segmentation results at the moments k−1 and k;
S3: training the designed point cloud registration network; and
S4: using the trained network to estimate a transformation matrix of two frames of point clouds.

### BRIEF DESCRIPTION OF THE DRAWINGS

FIG. 1 is a diagram of an overall design scheme of a laser radar point cloud registration method.

FIG. 2 is a diagram of a laser radar point cloud registration network.

FIG. 3 is a diagram of a static reference target feature extraction module.

FIG. 4 is a diagram of a point cloud segmentation and registration module.

### DETAILED DESCRIPTIONS OF THE EMBODIMENTS

The present disclosure will be further described below with reference to the accompanying drawings and specific embodiments. It should be understood that the following specific embodiments are only used to illustrate the present disclosure and are not intended to limit the scope of the present disclosure.

### Embodiment 1

The technical solutions provided by the present disclosure are described in detail below with reference to specific examples. It is to be understood that the following specific embodiments are only used to illustrate the present disclosure and are not intended to limit the scope of the present disclosure.

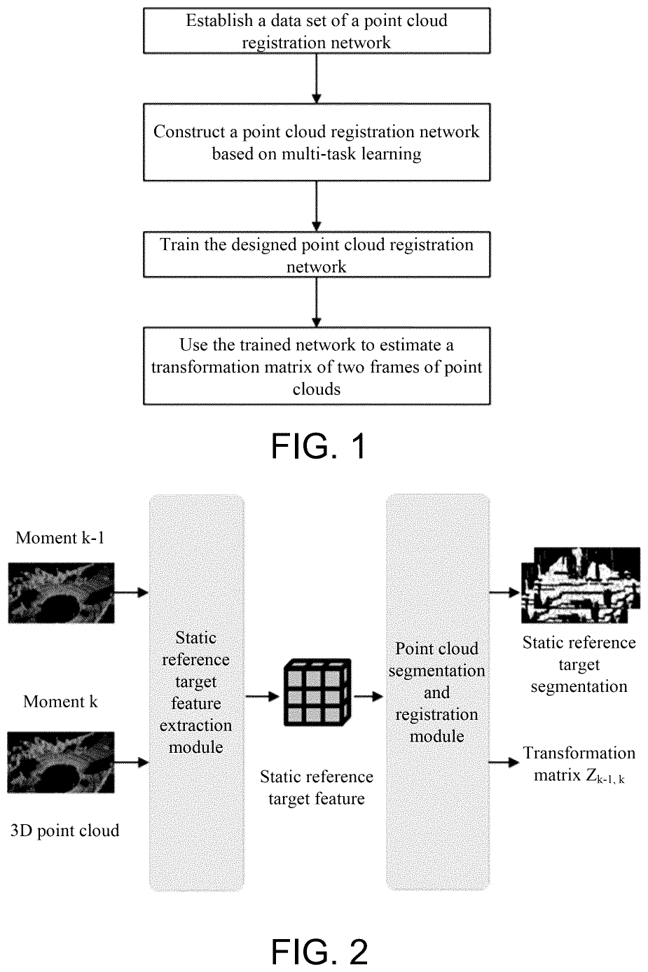

The present disclosure provides a laser radar point cloud registration method for an urban dynamic environment. The method includes: first, a data set of a point cloud registration network is established; then, a point cloud registration network based on multi-task learning is constructed; next, the designed point cloud registration network is trained; and finally, the trained network is used to estimate a transformation matrix of two frames of point clouds. According to the method, a three-dimensional (3D) point cloud is converted into a two-dimensional (2D) distance image, improving the efficiency of point cloud processing. According to the method, two tasks of point cloud segmentation and registration are executed, and due to a shared feature extraction module, point cloud registration can be carried out on the basis of reliable features of static reference targets, reducing errors caused by dynamic targets. An overall design scheme is shown in FIG. 1, and specific steps include: (1) establishing a data set of a point cloud registration network

A KITTI data set is currently the world's largest data set for evaluating artificial intelligence algorithms for autonomous driving scenarios, including real images and point cloud data collected from urban, rural, highway and other scenarios.

The KITTI data set provides 11 point cloud sequences with ground-truth transformation matrices, and further provides semantic categories (including a total of 19 categories) of each point in the 11 point cloud sequences. For urban traffic environments, trunks and buildings remaining unchanged in positions are selected as static reference targets. Therefore, the 19 categories in the KITTI data set are reclassified into three categories, i.e., trunks, buildings, and others.

Sequences 00-05 are used for training, sequences 06-07 are used for validation, and sequences 08-10 are used for testing.

### (2) Constructing a Point Cloud Registration Network Based on Multi-Task Learning

The point cloud registration network based on multi-task learning includes a static reference target feature extraction module and a point cloud segmentation and registration module, as shown in FIG. 2.

### 1) The Static Reference Target Feature Extraction Module

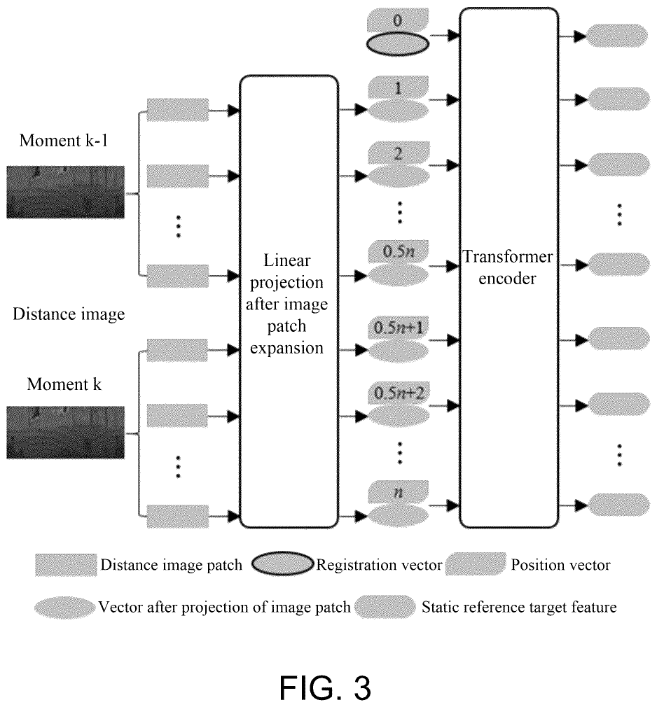

To improve the efficiency of point cloud processing, a 3D point cloud is converted into a 2D distance image by means of spherical projection, where point cloud coordinates (x, y, z) are converted into image coordinates (u, v):

$$( \begin{matrix}u \\ v\end{matrix} ) = ( \begin{matrix}\frac{1}{2} [ 1 - arctan ( y , x ) {π}^{- 1} ] w \\ [ 1 - ( arcsin ( z , {r}^{- 1} ) + {f}_{up} ) {f}^{- 1} ] h\end{matrix} )$$

where w and h represent a width and height of a distance image, r represents a distance of each point, r=\sqrt{x²+y²+z²}, f represents a vertical field of view of a laser radar, and fᵤₚ represents an upward angle of f. The coordinates (x, y, z), distance r, and reflectivity i of each frame of point cloud are stored in a distance image with a size of [w×h×5]. The static reference target feature extraction module inputs distance images at moments k−1 and k, and outputs static reference target features, as shown in FIG. 3.

The two distance images are decomposed into n image patches, n==(2×w×h)/(\dot{x}×\dot{h}), a size of each image patch is [\dot{w}×\dot{h}×5], and each image patch is expanded into a J-dimensional vector, J=5×\dot{w}×\dot{h}. Therefore, the two distance images are represented as a sequence \dot{Q}=[q₁, q₂, . . . , qₙ], q∈

[symbol]

Static reference target features are extracted by using a Transformer encoder, a vector dimension processed by the Transformer encoder is K, and the sequence \dot{Q} is converted into a sequence \ddot{Q}=[q₁E, q₂E, . . . , qₙE] through a learnable linear projection E∈ [symbol] . A learnable registration vector q₀∈ [symbol] is added to the sequence \ddot{Q}, to obtain a sequence [q₀, q₁E, q₂E, . . . , qₙE].

After image decomposition, position information of image patches is lost, and a learnable position vector P∈ [symbol] is added to the sequence \dot{\ddot{Q}}, to obtain a Transformer encoder input Q₀=[q₀, q₁E, q₂E, . . . , qₙE]+P.

The Transformer encoder has L modules, each of the modules includes a multi-head self-attention (MHSA) layer and a multi-layer perceptron (MLP) layer, layer normalization (LN) is performed before data enters each layer, and residual connections are used to fuse an output and input of each layer. A feature calculation process of a module 1 is as follows:

$${Q}_{1}^{′} = MSA ( LN ( {Q}_{1 - 1} ) ) + {Q}_{1 - 1} , 1 = 1 , 2 , ... , L$$

$${Q}_{1} = MLP ( LN ( {Q}_{1}^{′} ) ) + {Q}_{1}^{′} , 1 = 1 , 2 , ... , L$$

A static reference target feature Q_{L} is obtained based on Q₀ through the Transformer encoder.

### 2) The Point Cloud Segmentation and Registration Module

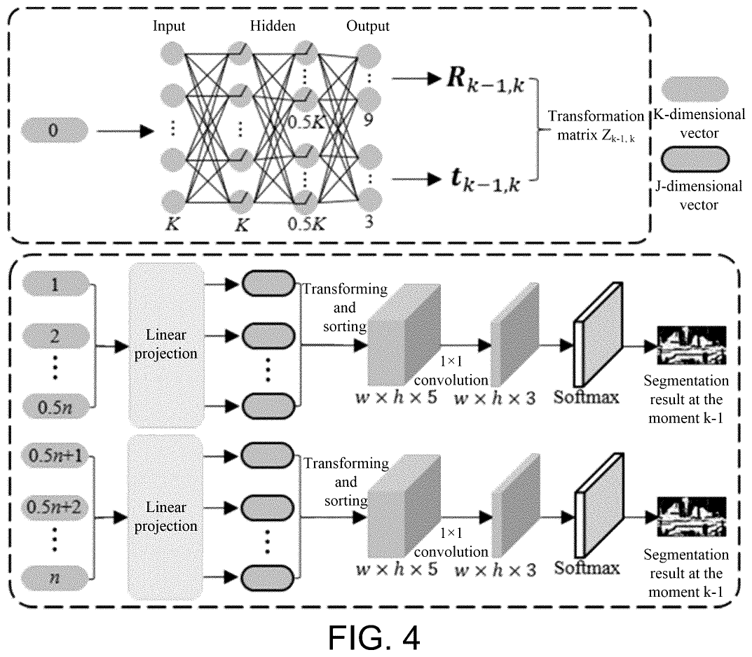

The point cloud segmentation and registration module is designed based on multi-task learning, as shown in FIG. 4. The static reference target feature Q_{L} is a sequence of n+1 K-dimensional vectors and configured to perform point cloud segmentation and registration.

A vector with an index 0 is used to estimate a transformation matrix Z_{k-1, k}=[R_{k-1, k}t_{k-1, k}] at the moments k−1 to k, vectors with indices 1 to 0.5n are used to obtain a static reference target segmentation result at the moment k−1, vectors with indices 0.5n+1 to n are used to obtain a static reference target segmentation result at the moment k, and the same operation, i.e., parameter sharing, is performed for segmentation at both the two moments.

The transformation matrix Z_{k-1, k} is obtained through a designed neural network, the neural network includes one input layer, two hidden layers, and one output layer, and a Tanh activation function is added to neurons in the hidden layers, to improve the generalization performance of the neural network.

A process of obtaining a static reference object segmentation result includes three steps: first 0.5n K-dimensional vectors are converted into 0.5n J-dimensional vectors through linear projection, then the 0.5n J-dimensional vectors are transformed and sorted to obtain a feature map with a size of [w×h×5], and finally the feature map is processed using a 1×1 convolution kernel and a Softmax function to obtain the static reference object segmentation results at the moments k−1 and k.

### (3) Training the Designed Point Cloud Registration Network

The designed point cloud registration network is trained by using the sequences 00-05 of the KITTI data set, network parameters are iterated and optimized through a gradient descent method, and the training process includes phases of forward propagation and back propagation. The sequences 06-07 of the KITTI data set are used for validation to select an optimal network model.

### (4) Using the Trained Network to Estimate a Transformation Matrix of Two Frames of Point Clouds

The performance of the point cloud registration network is tested by using the sequences 08-10 of the KITTI data set, and to fully illustrate the advantages of the method of the present disclosure, a representative point cloud registration algorithm is selected for comparison.

ICP (P. J. Besl and N. D. McKay, “A method for registration of 3-D shapes,” IEEE Transactions on Pattern Analysis and Machine Intelligence, vol. 14, no. 2, pp. 239-256, February 1992.)

RANSAC (M. A. Fischler and R. C. Bolles, “Random sample consensus: a paradigm for model fitting with applications to image analysis and automated cartography,” Communications of the ACM, vol. 24, no. 6, pp. 381-395, June 1981.)

DGR (C. Choy, W. Dong and V. Koltun, “Deep Global Registration,” in 2020IEEE/CVF Conference on Computer Vision and Pattern Recognition (CVPR), Seattle, WA, USA, 2020, pp. 2511-2520.)

HRegNet (F. Lu et al. “, HRegNet: A Hierarchical Network for Large-scale Outdoor LiDAR Point Cloud Registration,” in 2021IEEE/CVF International Conference on Computer Vision (ICCV), Montreal, QC, Canada, 2021, pp. 15994-16003.)

Comparison results are shown in the following table, and it can be seen that the method of the present disclosure greatly improves the accuracy of point cloud registration in dynamic environments while ensuring real-time performance.

| | Relative | Relative | |
|---|---|---|---|
| | translation | rotation | Running |
| Method | error/m | error/deg | time/ms |
| ICP | 0.402 | 0.701 | 379 |
| RANSAC | 0.314 | 0.835 | 440 |
| DGR | 0.168 | 0.286 | 1389 |
| HRegNet | 0.255 | 0.492 | 108 |
| The present | 0.182 | 0.304 | 69 |
| disclosure | | | |

Compared with the prior art, the present disclosure has the following advantages and beneficial effects:

1. In the present disclosure, a 3D point cloud is converted into a 2D distance image, improving the efficiency of point cloud processing.

2. In the present disclosure, two tasks of point cloud segmentation and registration are executed, and due to a shared feature extraction module, point cloud registration can be carried out on the basis of reliable features of static reference targets, reducing errors caused by dynamic targets.

It should be noted that the above content is merely used for explaining the technical idea of the present disclosure, and cannot limit the protection range of the present disclosure. Those of ordinary skill in the art may also make some improvements and modifications without departing from the principle of the present disclosure, and these improvements and modifications should also fall within the scope of protection determined in the claims of the present disclosure.

What is claimed is:

1. A laser radar point cloud registration method for an urban dynamic environment, comprising the following steps:
S1: establishing a data set of a point cloud registration network;
S2: constructing the point cloud registration network based on multi-task learning: the point cloud registration network based on the multi-task learning comprises a static reference target feature extraction module and a point cloud segmentation and registration module, wherein
1) the static reference target feature extraction module
a 3D point cloud is converted into a 2D distance image by means of spherical projection, wherein point cloud coordinates (x, y, z) are converted into image coordinates (u, v):
$$( \begin{matrix}u \\ v\end{matrix} ) = ( \begin{matrix}\frac{1}{2} [ 1 - arctan ( y , x ) {π}^{- 1} ] w \\ [ 1 - ( arcsin ( z , {r}^{- 1} ) + {f}_{up} ) {f}^{- 1} ] h\end{matrix} )$$
in the formula, w and h represent a width and height of a distance image, r represents a distance of each point, r=\sqrt{x²=y²+z²}, f represents a vertical field of view of a laser radar, and fᵤₚ represents an upward angle of f; the coordinates (x, y, z), distance r, and reflectivity i of each frame of point cloud are stored in a distance image with a size of [w×h×5];
the static reference target feature extraction module inputs distance images at moments k−1 and k, and outputs static reference target features;
the two distance images are decomposed into n image patches, n=(2×w×h)/(\dot{w}×\dot{h}), a size of each image patch is [\dot{w}×\dot{h}×5], each image patch is expanded into a J-dimensional vector, J=5×\dot{w}×\dot{h}, and the two distance images are represented as a sequence \dot{Q}=[q₁, q₂, . . . , qₙ], q∈ [symbol]
static reference target features are extracted by using a Transformer encoder, a vector dimension processed by the Transformer encoder is K, the sequence \dot{Q} is converted into a sequence \ddot{Q}=[q₁E, q₂E, . . . , qₙE] through a learnable linear projection E∈ [symbol] , and a learnable registration vector q₀∈ [symbol] is added to the sequence \ddot{Q}, to obtain a sequence \ddot{\dot{Q}}=[q₀, q₁E, q₂E, . . . , qₙE];
a learnable position vector P∈ [symbol] is added to the sequence \dot{\ddot{Q}} to obtain a Transformer encoder input Q₀=[q₀, q₁E, q₂E, . . . , qₙE]+P;
the Transformer encoder has L modules, each of the modules includes a multi-head self-attention (MHSA) layer and a multi-layer perceptron (MLP) layer, layer normalization (LN) is performed before data enters each layer, residual connections are used to fuse an output and input of each layer, and a feature calculation process of a module 1 is as follows:
$${Q}_{1}^{′} = MSA ( LN ( {Q}_{1 - 1} ) ) + {Q}_{1 - 1} , 1 = 1 , 2 , ... , L$$
$${Q}_{1} = MLP ( LN ( {Q}_{1}^{′} ) ) + {Q}_{1}^{′} , 1 = 1 , 2 , ... , L$$
a static reference target feature Q_{L} is obtained based on Q₀ through the Transformer encoder;
2) the point cloud segmentation and registration module
the static reference target feature Q_{L} is a sequence of n+1 K-dimensional vectors, a vector with an index 0 is used to estimate a transformation matrix Z_{k-1, k}=[R_{k-1, k}t_{k-1, k}] at the moments k−1 to k, vectors with indices 1 to 0.5n are used to obtain a static reference target segmentation result at the moment k−1, vectors with indices 0.5n+1 to n are used to obtain a static reference target segmentation result at the moment k, and the same operation, i.e., parameter sharing, is performed for segmentation at both the two moments;
the transformation matrix Z_{k-1, k} is obtained through a designed neural network, the neural network comprises one input layer, two hidden layers, and one output layer, and a Tanh activation function is added to neurons in the hidden layers;
a process of obtaining a static reference object segmentation result comprises three steps: first converting 0.5n K-dimensional vectors into 0.5n J-dimensional vectors through linear projection, then transforming and sorting the 0.5n J-dimensional vectors to obtain a feature map with a size of [w×h×5], and finally processing the feature map using a 1×1 convolution kernel and a Softmax function to obtain the static reference object segmentation results at the moments k−1 and k;
S3: training the designed point cloud registration network; and
S4: using the trained network to estimate a transformation matrix of two frames of point clouds.
